(19) United States
(12) Patent Application Publication
(10) Pub. No.: US 2008/0010800 A1
(43) Pub. Date: Jan. 17, 2008

(54) Automotive Wheel Assembly Removal Tool Actuators

(75) Inventors: Theodore J. Bergman, Maria Stein, OH (US); Jon E. Bergman, Maria Stein, OH (US); John C. Huelsman, Maria Stein, OH (US)

Correspondence Address: THE WEBB LAW FIRM, P.C., 700 KOPPERS BUILDING, 436 SEVENTH AVENUE, PITTSBURGH, PA, 15219, US

(73) Assignee: WEST CENTRAL OHIO TOOL DISTRIBUTORS, LTD., Maria Stein, OH (US)

(21) Appl. No.: 11/862,693

(22) Filed: Sep. 27, 2007

Related U.S. Application Data
(63) Continuation-in-part of application No. 11/294,117, filed on Dec. 5, 2005, now Pat. No. 7,296,330.
(63) Continuation-in-part of application No. 10/027,371, filed on Dec. 20, 2001, now Pat. No. 6,971,149.

(51) Int. Cl. B23P 19/04

(52) U.S. Cl. 29/254

(57) ABSTRACT

A wheel assembly removal apparatus and method for use in the automotive maintenance and repair industry. The apparatus is adapted to remove a wheel assembly, and components thereof that may have become seized together, from a vehicle chassis for maintenance and repair while minimizing time and cost, and the possibility for damage to the assembly. The apparatus includes a linear actuator, a cross bar, and a rotor securing tool connected on one side to the linear actuator and adapted on the other side to connect to a rotor. The apparatus also includes at least one push link attached to an end of the cross bar, the push link being adapted with a length to seat and urge against a vehicle chassis. The linear actuator is configured to apply a load to the cross bar such that the load is transferred through the push link to the vehicle chassis in a direction parallel to the axel of the wheel assembly.

### CROSS-REFERENCE TO RELATED APPLICATIONS

This application claims the benefit of the earlier filing of and is a continuation-in-part application of U.S. utility patent application Ser. No. 11/294,117, filed Dec. 5, 2005, which is a continuation-in-part of U.S. utility patent application Ser. No. 10/027,371, filed Dec. 20, 2001, now U.S. Pat. No. 6,971,149, issued Dec. 6, 2005, all of which are hereby incorporated by reference herein.

### BACKGROUND OF THE INVENTION

1. Field of the Invention

This invention relates to tools and particularly to a tool adapted to remove a wheel assembly from a vehicle chassis for automotive maintenance and repair. More specifically, the invention relates to a durable, inexpensive, and reconfigurable apparatus for removal of the wheel assembly from the vehicle chasses of a plurality of original equipment manufacturer (hereafter also referred to as “OEM”) automotive product lines.

2. Description of Related Art

In the various automotive vehicle industries, including for purposes of illustration but not limitation, wheel and brake servicing and repair, those with skill in the art have long-recognized the need for an improved method of removing the various components of a wheel assembly without damage that can occur to, for example, without limitation, the rotors, hubs, bearings, spindles, and axles.

In the past, service personnel, technicians, and mechanics have had to resort to blow torches, mallets, hammers, pry bars, and the like to remove and break free the various wheel assembly components that may be seized together from the accumulation of dirt, dust, moisture, and from corrosion and cold welding that can occur from various forces, loads, and galvanic and frictional interaction between the wheel assembly components. Such corrosive and cold welding type seizing is further exacerbated by the combined effect of heavy load conditions experienced by many types of consumer, commercial, industrial, and military vehicles. Some technicians and mechanics also attempt to pull the assembly apart by securing pulling devices to one of the wheel assembly engagement members, typically referred to as studs or lugs by those having skill in the art. This method does not evenly distribute the pulling forces to the wheel assembly and often results in deformation and damage to the engagement members and to the wheel assembly, which can require replacement of the deformed and damaged parts, which further adds to and increases the labor and part maintenance costs.

Occasionally, vehicle manufacturers will suggest alternative removal methods including, for example, the installation of longer bolts or studs from the rear of the assembly that can be employed to force apart the components of the wheel assembly from the wheel hub, spindle, or axle. However, this method is generally ineffective to combat severely corroded parts and is generally incompatible for use with most OEM vehicle configurations such as, for example, four-wheel drive vehicles that incorporate complex axle component assemblies and difficult to access service configurations and vehicle locations.

As a result of such difficulty and in light of the increased expense and ineffectiveness of most prior art devices, mechanics generally resort to the pry bar, hammer, and mallet methods that typically impart unevenly applied impact forces, which most often deforms and damages the wheel assembly components including the hub, rotor, bearings, axle, and spindle.

As noted herein, the problem of seized wheel assembly components is especially common in vehicles that are adapted to carry frequently heavy loads and that are subject to particularly severe shock loads such as those experienced in off-road and various industrial and construction applications and environments. Removing the seized components of load carrying vehicles can take dozens of forceful hammer blows to the rotor, and often requires the use of a torch to create temperature differentials across and between the seized parts.

In severely corroded and seized situations, the torch is used to actually cut the non-removable parts from the assembly so that replacement components can be supplied. This torch removal technique is dangerous, time consuming, exhausting, and many times will cause damage to the components that would only otherwise require removal and servicing. As a result of such problems in removing and servicing various types of wheel assemblies and related components, many service facilities expend many extra man-hours each day removing seized components. Further, despite their best efforts, the technicians and mechanics often cannot avoid irreparable damage to the wheel assembly components during removal, the costs of which are borne in part by the facility, any warranty provider, and often in most part by the customer or vehicle owner.

What has been needed, but as yet unavailable, is a device that addresses some of the long-standing problems in the art. Some attempts have been made to improve devices for use in other technology areas. For example, the value of a slide hammer type device in imparting tensile impulse loads has been attempted in the automotive services industry.

Prior art devices and methods for applying tensile impulse loads have not been compatible for wide spread uses and do not properly impart effective and efficient axial forces. For example, in U.S. Pat. No. 3,106,012 to Comer and U.S. Pat. No. 3,003,230 to Fornes, slide hammer devices are incorporated in axle pullers. Even earlier, U.S. Pat. No. 2,377,304 to Appel incorporated a slide hammer into a device for pulling sleeves from internal combustion engines.

More recently, U.S. Pat. No. 4,283,827 to Abel utilized a slide hammer device in a tool for removing axle spindles. While these devices attempt to impart effective tensile impulse loads on the object intended to be pulled apart or removed, none of the attempts to date have offered the reliable and novel aspects contemplated by the present invention, nor have they been compatible for use with the myriad OEM vehicles and components presently in the marketplace.

Instead, the prior art devices have been markedly limited in application and compatibility and when not entirely effective for the intended or desired purpose, such devices have often failed to establish any effective solution to the particularly troublesome seized wheel assembly components that may be severely corroded and welded together. The limited attempts of the prior art that have sought to address the particular issues related to one type of wheel assembly have been unable to operate with wheel assembly designs other than the one or two configurations contemplated.

The need remains for an apparatus that can be easily setup and reconfigured to ensure substantially axial transfer of generally uniform forces, that can be utilized on a variety of vehicles, and that can more readily remove and separate the components of a corroded wheel assembly, while minimizing or eliminating potential damage to the assembly during unseizing and separation.

The present invention meets the above described and other needs without adding any complexity, inefficiencies, or significant costs to implementation in existing applications and environments. In fact, the preferred apparatus according to the present invention can be implemented with relatively low-cost materials and components that can be easily adapted according to the principles of the present invention. The various embodiments of the present invention disclosed are readily adapted for preferable ease of manufacture, low fabrication and setup costs, effectiveness of operation, and for wide compatibility with various OEM components. Further, service personnel, technicians, and mechanics can employ the device and apparatus according to the principles of the instant invention without any additional training and without any additional tooling or equipment other than the improved wheel assembly removal apparatus and the various configurations thereof that are contemplated herein.

### SUMMARY OF THE INVENTION

In its most general configuration, the present invention advances the state of the art with a variety of new capabilities and overcomes many of the shortcomings of prior devices in new ways. The present invention is an apparatus for removing an automotive wheel assembly from a vehicle chassis. The apparatus includes a linear actuator, a cross bar, and a rotor securing tool connected on one side to the linear actuator and adapted on the other side to connect to a rotor. The apparatus also includes at least one push link attached to an end of the cross bar, the push link being adapted with a length to seat and urge against a vehicle chassis. The linear actuator is configured to apply a load to the cross bar such that the load is transferred through the push, link to the vehicle chassis in a direction parallel to the axel of the wheel assembly. The linear actuator can be a hydraulic, pneumatic, or pneudraulic device. The linear actuator can also be a plunger-cylinder assembly.

The push link of the apparatus can be adjustably and movably attached to the cross bar. The push link can also be hingedly attached to the cross bar, and can have a fixing member. The push link can also include a gripping member. The gripping member can be generally tubular. The gripping member can also include a cavity. The gripping member can also include a lip.

The apparatus can include rocker clamps attached to the rotor securing tool. The apparatus can also include a slide hammer assembly connected to the linear actuator. The apparatus can also include a biasing member disposed between the cross bar and the rotor securing tool.

The present invention also includes a method for removing an automotive wheel assembly from a vehicle chassis. This method includes the steps of connecting a rotor securing tool to a rotor of the wheel assembly and connecting a linear actuator to the rotor securing tool. The linear actuator is adapted to push a cross bar relative to the linear actuator. The method also includes connecting a push link to the vehicle chassis, the push link being connected to the cross bar, and having the linear actuator apply a load to the cross bar in the direction of the vehicle chassis, causing the push link to push against the vehicle chassis. The linear actuator used can be a hydraulic, pneumatic, or pneudraulic device. The linear actuator can also be a plunger-cylinder assembly.

The push link used can be adjustably and movably attached to the cross bar, or the push link can be hingedly attached to the cross bar. If the push link is hingedly attached, a fixing member can be provided to fix the hingedly attached push links in a position. The push link used can include a gripping member which can be generally tubular or can include a cavity. The rotor securing tool can be connected to the rotor with rocker clamps. The push link can also include a push plate.

The method can also include attaching a slide hammer assembly to the linear actuator, and then sliding a hammer in the slide hammer assembly to generate linear momentum until it makes contact with a hammer stop, such that the hammer delivers an impact load pulling the wheel assembly away from the vehicle chassis. The method can also include the step of heating the appropriate structures of the wheel assembly to impart temperature differential induced stresses across the interface between the wheel assembly components that are seized together.

These variations, modifications, and alterations of the various preferred embodiments may be used either alone or in combination with one another as can be better understood by those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures, wherein like reference numerals across the several drawings, figures, and views refer to identical, corresponding, and or equivalent elements, features, components, and parts:

FIG. 1 is an elevation view, in reduced scale, of a wheel assembly removal apparatus according to the present invention shown attached to a wheel assembly;

FIG. 2 is an elevation view, in reduced scale, of a variation of a wheel assembly removal apparatus of FIG. 1;

FIG. 3 is an elevation view, in reduced scale, of a modified wheel assembly removal apparatus according to the present invention shown attached to a wheel assembly;

FIG. 4 is an elevation view, in reduced scale, of another variation of the wheel assembly removal apparatus according to the present invention;

FIG. 5 is a plan view, in reduced scale and with certain structure removed for purposes of illustration, of another variation of the wheel assembly removal apparatus according to the principles;

FIG. 6 is a section view, rotated and in modified scale and taken about section line 6-6 of FIG. 5, of the modified wheel assembly removal apparatus of FIG. 5;

FIG. 7 is a partial detail view, in modified scale, of a portion of the structure of FIG. 6 with certain structure removed for purposes of further illustration;

FIG. 8 is an elevated perspective view, in modified scale, of another variation of the preferred embodiments that can include various hydraulic assist components;

FIG. 9 is a detail view of a portion of the assembly depicted in FIG. 8;

FIG. 10 is an exploded view of various of the elements of the modification of FIG. 8;

FIG. 11 is a detail view of a modified component of the assembly of FIGS. 8 and 10;

FIG. 12 is a perspective view of an embodiment of a wheel assembly removal apparatus in accordance with the present invention;

FIG. 13 is a side view of the apparatus of FIG. 12 engaged with a vehicle chassis;

FIG. 14 is a side sectional view of an embodiment of a cross bar with channels;

FIG. 15 is a side view of an embodiment of a cross bar with hingedly attached push links.

FIG. 16 is a perspective view of an embodiment of a gripping member in accordance with the present invention.

FIG. 17 is a side view of the gripping member shown in FIG. 16.

FIG. 18 is a side view of an embodiment of the apparatus of FIG. 12 engaged with a vehicle chassis.

FIG. 19 shows an embodiment of the apparatus shown in FIG. 18 with a push plate attached to one of the push links.

FIG. 20 is a side sectional view of an embodiment of a cross bar with an attached gusset;

FIG. 21 is a side view of a cross bar with an attached gusset according to the embodiment shown in FIG. 20.

Also, in the various figures and drawings, the following reference symbols and letters are used to identify significant features, dimensions, objects, and arrangements of elements described herein below in connection with the several figures and illustrations: A, AR, CS, HS, JS, Li, L, L′, R, RM, M, SK, WA, X, and Z.

### DESCRIPTION OF THE PREFERRED EMBODIMENTS

The wheel assembly removal apparatus according to the present invention demonstrates a significant step forward in the field of vehicle maintenance tools, and more specifically, in the field of wheel assembly removal tools. Many undesirable, ineffective, and unsuccessful attempts have been made to create a wheel assembly removal apparatus having the convenience and efficiency of the present invention.

The preferred wheel assembly removal apparatus has wide application for all wheel based vehicles that incorporate wheel or rotating assemblies that are subject to removal for maintenance and replacement. The preferred configurations and described alternatives, modifications, and variations of the wheel assembly removal apparatus of the instant invention overcome prior shortcomings and accomplish new and novel solutions to the prior art problems with vastly improved configurations and arrangements of inventive elements that are uniquely configured, and which demonstrate previously unavailable capabilities, and wide compatibility for use with any original equipment manufacturer (OEM) vehicles.

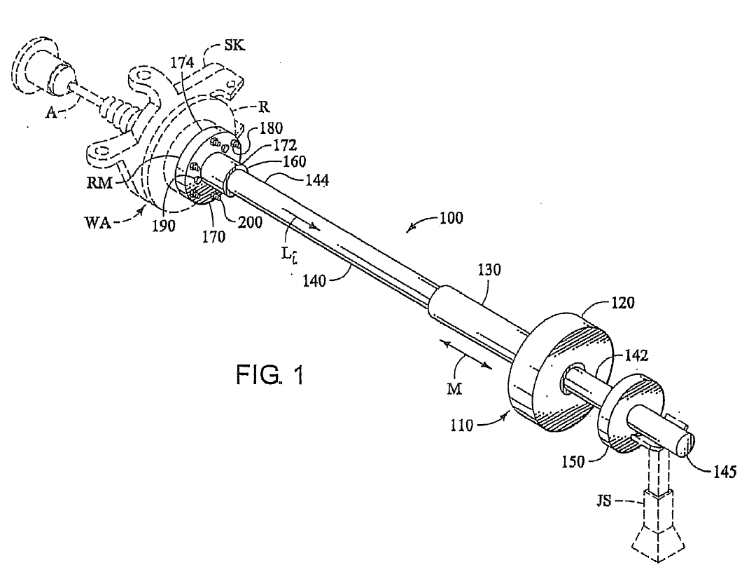

With reference now to the accompanying figures and specifically to FIG. 1, in one of the many preferable configurations, the wheel assembly removal apparatus 100 incorporates, among other elements, a slide hammer assembly 110 that includes a hammer 120 secured to a hollow slide tube 130. The hollow slide tube 130 is received on a hollow or solid slide shaft 140 upon which the hollow slide tube 130 and hammer 120 can be moved, as indicated generally by arrows identified by reference letter M.

The slide shaft 140 incorporates a hammer stop 150 near the distal end 142 and a distally projecting support extension 145. A coupler 160 is formed at the proximal end 144 of the slide shaft 140 and is configured to releasably engage an interchangeable rotor securing tool 170. The interchangeable rotor securing tool 170 releasably attaches to the coupler 160 at the distal end 172 and to a rim mounting surface RM at the proximal end 174.

In additional alternative, optional, and preferred configurations, the coupler 160, instead of being incorporated in the form of the extending stem with distal end 172, may be formed as an integral and flush feature. More specifically, the rotor securing tool 170 may take the form of a large, flat disk with threads or other attachment features included in a generally central bore approximately in the same position as the coupler 160 shown in the various figures. One possibly desirable variation can simply incorporate a centrally formed countersunk or through bore that can further include internal threads or other interlocking features to releasably attach proximal end 144 to the modified coupling feature.

In operation, a user rapidly accelerates the hammer 120 and hollow slide tube 130 to generate linear momentum, from the proximal end 144 of the slide shaft 140 to impact the hammer stop 150, which creates an operational impact load, denoted generally by the arrow identified by the reference letter Li, as the hammer 120 strikes the hammer stop 150. The user may grip the hollow slide tube 130 or the hammer 120 to accelerate the hammer assembly 110.

In this way, the user creates and transfers the momentum of the accelerated slide hammer assembly 110 to the wheel assembly WA. Those with skill in the art can understand that the resulting impact load Li is transferred through the slide shaft 140, the coupler 160, and the interchangeable rotor securing tool 170 to the rim mounting surface RM. It has been found that repeated operation of the apparatus 100 in this way can unseize and separate even the most tightly joined wheel assembly components.

One variation of the preceding embodiment includes a plurality of bearings (not shown) in the slide tube 130. The addition of such bearings reduces the friction between the slide shaft 140 and the slide tube 130. Alternatively, the slide shaft 140 may include a plurality of bearings upon which the slide tube 130 travels. Further, the slide tube 130 and slide shaft 140 may include a low friction coating.

Yet another embodiment of the apparatus 100 shown in FIG. 1 incorporates a pneumatic or hydraulic cylinder (not shown) as the slide shaft 140. A pneumatic cylinder may be used as the slide shaft 140 by simply adding a compressed air connection port at either end of the hollow slide tube 140. The modified slide shaft 140 would preferably contain a pneumatic piston that may be connected to the slide hammer assembly 110 in a number of ways recognizable by one with skill in the art. This embodiment would allow the operator to operate the apparatus 100 remotely and to stand clear of all moving components of the apparatus 100, as well as the wheel assembly WA, as it is separated.

The rim mounting surface varies with the type of OEM vehicle. Typically, in one example, the rim mounting surface RM is either on the rotor R or the hub. One with skill in the art can recognize that the wheel assembly WA generally includes a spindle (not shown), a wheel bearing (not shown), a hub (not shown), and a rotor R. The particular wheel assembly WA depicted in FIGS. 1, 2, 3, and 4 illustrates a configuration wherein the rotor R is located on the wheel side of the hub, also the side wherein the apparatus 100 attaches in the referenced figures.

However, there are other types of vehicles in which the hub is on the wheel side of the rotor R, such as late model full size Dodge brand trucks, wherein the wheel assembly removal apparatus 100 is equally effective. The impact load Li generated during operation of the apparatus 100 breaks loose the seized components of the wheel assembly WA, which may include, for example, wheel bearings, hub, rotor R, and axle components, from the spindle and axle A.

The apparatus 100 may be constructed out of virtually any durable and relatively strong and fatigue resistant material. One preferable embodiment utilizes commercially available carbon steel components due to the low cost of carbon steels and their durability and high strength. The apparatus may be constructed out of corrosion resistant and spark resistant materials for use in hazardous environments. Also, the various components of the apparatus 100 may be furnished in a variety of finishes, including, for example, a painted finish, a coated finish, a dielectric coating, a plated finish, or a galvanized coating.

The preferred embodiment is light enough that a single person can carry and set-up the apparatus 100. Additionally, a high ratio of the weight of the slide hammer assembly 110 to the apparatus 100 weight is preferred. Accordingly, a hollow slide shaft 140 and a small hammer stop 150 are preferred. In this way, the momentum of the moving slide hammer assembly 110 is transferred, on impact with the hammer stop 150, mostly to the wheel assembly WA and energy is not unduly wasted in accelerating unnecessary mass of the apparatus 100.

In one of many variations of the instant invention, the apparatus 100 also preferably includes a plurality of engagement hole patterns 180, each containing at least two engagement holes, formed on the interchangeable rotor securing tool 170. More specifically, one embodiment of the interchangeable rotor securing tool 170 may preferably include a four engagement hole pattern, a six engagement hole pattern, and an eight engagement hole pattern, or more, and all incorporated on a single tool 170. Similarly, additional holes may be formed to facilitate removal of other components of the wheel assembly, such as, for purposes of example but not for purposes of limitation, a wheel bearing assembly. In this instance, additional hole patterns such as hole pattern 190 can be included, which can be used for bolts used to engage wheel bearing components that may need repair and removal via the impact load removal techniques described herein.

Alternatively, the interchangeable rotor securing tool 170 may include a three engagement hole pattern, a five engagement hole pattern, an eight engagement hole pattern on a single tool 170, and combinations thereon. Further, each of the plurality of engagement hole patterns 180 may be formed on individual interchangeable rotor securing tool 170.

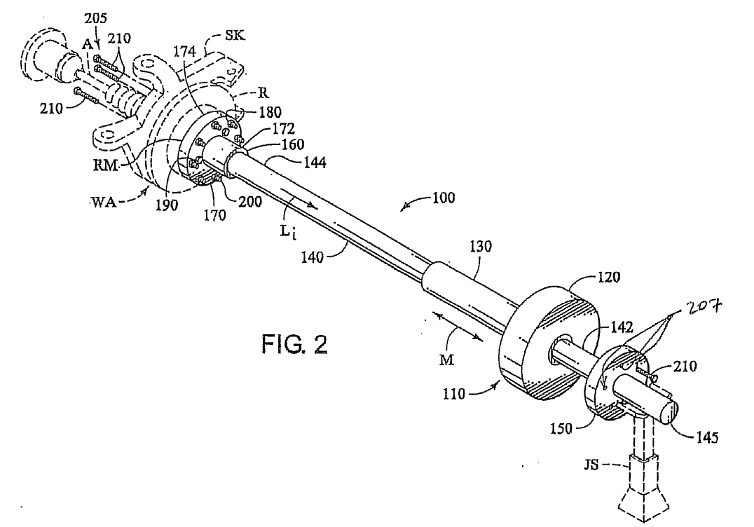

These engagement hole patterns 180 are not limited to aligning with engagement members 200, but may also align with the wheel bearing (not shown) removal bolt patterns of many vehicles, such as hole pattern 190. Referring now also to FIGS. 1, 3, and 4, additional modifications are illustrated that include a three engagement hole pattern and a six engagement hole pattern. FIG. 2 illustrates a modified embodiment that incorporates a three engagement hole pattern and an eight engagement hole pattern.

The coupler 160 is preferably adapted to enhance compatibility in that it enables a single slide hammer assembly 110 to be used with any number of interchangeable rotor securing tool 170. Therefore, one slide hammer assembly 110 may be used with any number of interchangeable rotor securing tool 170 that are adapted for both foreign and domestic vehicles, including, for example, cars, trucks, vans, buses, aircraft, recreation, and military vehicles.

The coupler 160 may take the form of a male threaded connection on the slide shaft 140 for engagement by a female threaded receiver on the interchangeable rotor securing tool 170. Alternatively, one with skill in the art would recognize that the coupler 160 may be formed to include quick release type fasteners, cotter pin type fasteners, bayonet fasteners, and any number of other recognized joining methods.

Additional embodiments of the interchangeable rotor securing tool 170 allow the tool to be securely connected to or coupled to the rim mounting surface to transfer a substantially axial impact load Li approximately uniformly to the rim mounting surface RM. This variation may be used with any of the preceding embodiments and incorporates an interchangeable rotor securing tool 170 that is adapted to be in contact with a substantial portion of the rim mounting surface RM, in addition to engaging the engagement members 200.

While it is preferably that all the engagement members 200 be fastened to the apparatus 100 to maximize the load distribution and minimize the potential for damaging the engagement members 200, the apparatus 100 can function when fastened to at least one engagement member 200. Then, with the engagement members 200 extending through at least one of the engagement hole patterns 180 and fastened to the rotor securing tool 170, the slide shaft 140 is preferably approximately orthogonal to the rim mounting surface RM and will transfer a substantially axial operational impact load Li. Additionally, the substantial amount of contact area of the rim mounting surface RM and the scouring tool 170, when properly connected, ensures a substantially distributed load transfer interface for the uniform transfer of loads from the rotor securing tool 170 to the rim mounting surface RM.

Further, the apparatus 100 also preferably can include a support extension 145 at the distal end of the slide shaft 140. The support extension 145 allows the operator to rest the distal end of the apparatus 100 on a jack stand JS. As described before, the operator does not have to support the weight of the apparatus 100 while in use and during setup. Additionally, with the support extension 145 on a jack stand JS the operator can ensure that the slide shaft 140 is substantially level, if desired, and substantially orthogonal to the rim mounting surface RM to therefore transfer the greatest amount of axial force.

An additional variation of the support extension 145 may include a distal end connection for securing additional tools. The apparatus 100 may then be used as a tool to impart compressive impulse forces and may be used, for example, to unseize axles by driving them toward the transmission.

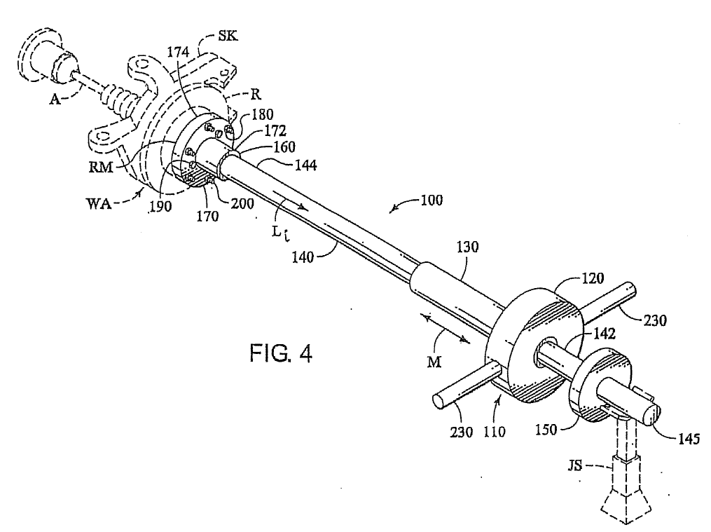

A further variation of any of the preceding embodiments may also include a dual hand operation mechanism 230, as illustrated in FIG. 4. The mechanism 230 operates best with hands of the operator grasping the moving portion of the apparatus 100, namely, the hollow slide hammer assembly 110, prior to accelerating the slide hammer assembly 110 on the slide shaft 140. This mechanism 230 minimizes the possibility of the operator getting one a hand caught between the slide hammer assembly 10 and the hammer stop 150.

One embodiment of the dual hand operation mechanism includes two spring loaded handles secured to the hammer 120. A pin (not shown) extends from the handles through the hammer 120 to the slide shaft 140. In this embodiment, the slide shaft 140 includes a plurality of ledges (not shown) that engage the pins.

To slide the slide tube 130 and hammer 120 along the slide shaft 140, the user must place one hand on each handle and pull the handles, and therefore the push pins, outward away from the slide shaft 140, therefore disengaging the pins and ledges. One with skill in the art would recognize the myriad of potential dual hand mechanisms 230 that may be successfully applied to this apparatus 100 in the context of the preceding descriptions.

A further variation of any of the preceding embodiments may include a non-slip gripping surface on the hollow slide tube 130, the hammer 120, and the operation mechanism 230. The surface textures may include, for example, work and grip surfaces that are also formed to have stipple and or dimple patterns of raised portions. Further, the hollow slide tube 130 and the operation mechanism 230 may include grip type devices that conform to the shape of a hand gripping a cylindrical object.

Any of the preceding configurations and embodiments may also be adapted to include any one of a number of releasably engagable retainer assemblies. This retainer assembly 205 loosely retains the wheel assembly WA to the vehicle chassis so that the operator, apparatus 100, and the wheel assembly WA are controlled when the impact load Li breaks free the seized components.

The retainer assembly 205 may, in one variation, include at least one fastener. One such embodiment incorporates at least one retainer bolt 210 that loosely secures the wheel assembly WA to the vehicle chassis during operation. For example, in one of many possible applications as shown in FIG. 2, the OEM bolts that are used to tightly secure the bearing of the wheel assembly WA to the steering knuckle SK or chassis are removed and replaced with at least one fastener that may be extra long bolts, such as bolts approximately 2″ to 8″ long, or longer as needed, which enable the wheel assembly to break free when the impact load Li is applied.

Further, the retainer bolts 210 restrain the wheel assembly WA and apparatus 100 to the vehicle to control the breakaway of the wheel assembly WA from the vehicle and prevent the wheel assembly WA and the apparatus from dropping to the ground. In other alternative arrangements, the at least one fastener or retainer bolt 210 can also include a lug nut, an expandable bolt, a locking shear pin, a flexible strap, any of which can be used alone, in place of, or in combination with the at least one fastener, as well as in combinations of any of such components. Additionally, a jack stand JS may be located under the coupler 160 to control the weight of the wheel assembly WA and the apparatus 100 when the wheel assembly WA breaks free.

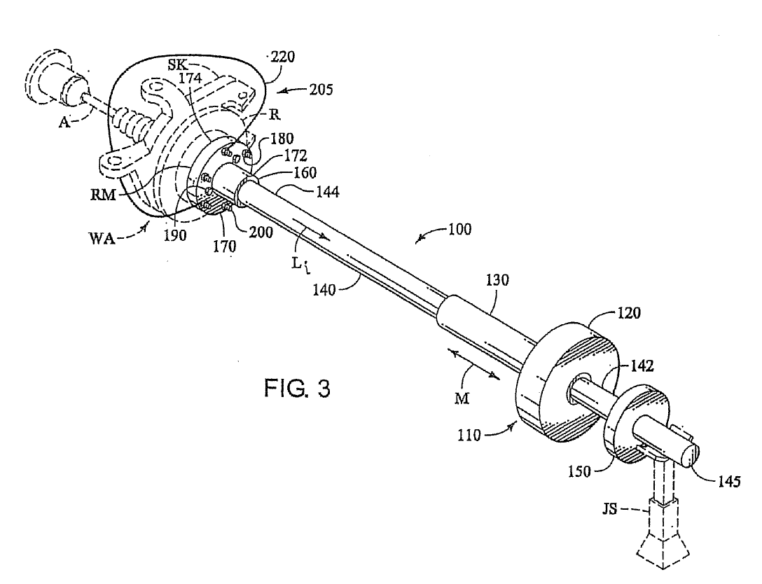

Also, further embodiments of the releasably engagable retainer assembly 205 incorporates at least one flexible and adjustable retainer device 220, as illustrated in FIG. 3. The flexible and adjustable retainer device 220 may preferably be formed from chains, wire ropes, elastomeric restraints, bungees, and any number of strap like devices and combinations thereof. These flexible adjustable retainer devices 220 may be releasably engaged by the interchangeable rotor securing tool 170 or the slide shaft 140 and may be wrapped around and through the wheel assembly chassis mount, steering knuckle SK, or virtually any vehicle member that is securely attached to the frame.

Any of the preceding configurations and embodiments may also be adapted to include a means for attaching the releasably engagable retainer assembly 205 to the apparatus 100 when not in use. One such embodiment may include retainer bolt recesses formed into the hammer stop 150 as a storage holder 207 in which the retainer bolts 210 may be secured when the apparatus is not in use, as illustrated in FIG. 2. Additional embodiments may include retainer bolt recesses in the hammer 120, interchangeable rotor securing tool 170, or the device support extension 145. Similar attachment means may be incorporated into the flexible adjustable retainer device 220 embodiments.

As represented in the various figures, the wheel assembly removal apparatus 100 is not necessarily shown to scale but is shown in one of many possible and equally desirable representative relative dimensional proportions, as will be apparent to those with skill in the art. For example, although the wheel assembly removal apparatus 100 is shown to have generally cylindrical components, any of a wide variety of equally suitable cross-sectionally shaped profiles are available and would be compatible for purposes of and contemplated by the wheel assembly removal apparatus 100 of the present invention in any of its described and contemplated embodiments, variations, and modified forms.

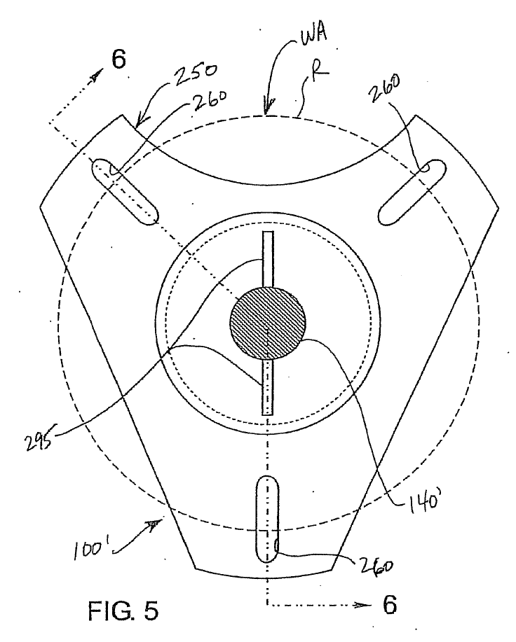

With continued reference to the preceding various figures, reference is now also specifically made to FIGS. 5, 6, and 7, which illustrate another alternative variation that can be included in whole or in part with any of the preceding embodiments and alternatives thereto already described herein. In FIG. 5, those having skill in the art may be able to further understand that the instant invention is also directed to an automotive wheel assembly removal apparatus 100′ having an interchangeable rotor securing tool 250 that is similar in certain respects to other embodiments described herein.

However, unlike previous variations and modifications, the instant alternative arrangement of the securing tool 250 incorporates a housing 255 of tool 250 that is preferably formed with a plurality or two or more engagement slots 260 that are adapted to establish an adjustment capability to the interchangeable securing tool 250. In this modified variation, the housing 255 of tool 250 establishes in interior recess that is seated over lugs and hub portions of the contemplated wheel assembly(ies) WA and is further configured to be coupled against the rotor or rotor plate R thereof.

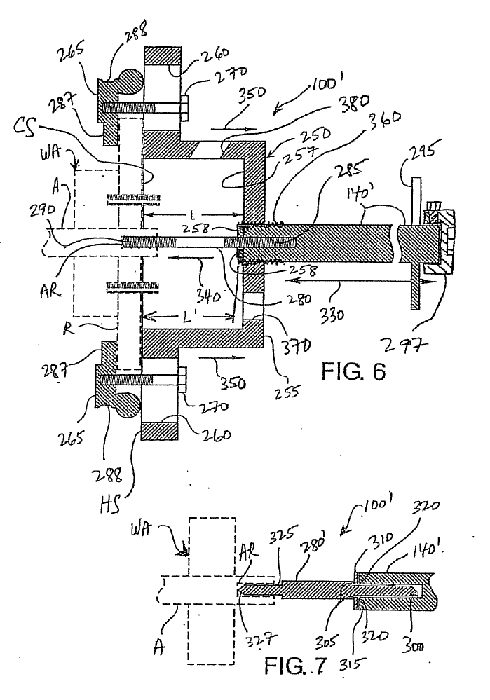

Additionally, the instant alternative arrangement 100′ further incorporates a plurality or two or more rocker clamps 265 that cooperate with the slots 260 to clamp a component such as the rotor plate R (FIGS. 5 and 6) thereby securing the interchangeable rotor securing tool 250 to the wheel assembly WA. As can be understood with continued reference to FIG. 6, the rocker clamps 265 can be fastened to the interchangeable rotor securing tool 250 with bolts 270 that can be threaded into the rocker clamps 265 or that can be fastened with nuts (not shown) through holes that may alternatively be formed in the rocker clamps (not shown).

In this arrangement 100′, the interchangeable rotor securing tool 250 can be adapted for use with rotor plates such as rotor R as well as any number of differently configured rotor plates having various thicknesses and diametrical dimensions and configurations. For purposes of establishing compatibility with a vast range of wheel assemblies, including wheel assembly WA, the rocker clamps 265 may incorporate one or more reliefs or recessed portions 287, 288 that can be shaped and sized so that the rocker clamps 265 can be positioned inside certain portions of the contemplated wheel assemblies without interference from components and structural features of such wheel assemblies. In this way, fewer components of the wheel assemblies must be removed for purposes of operating the wheel assembly removal apparatuses 100, 100′ according to the principles of the instant invention.

With continued reference to FIG. 6, the instant modification also contemplates incorporation of an optional or preferred axle impact shaft, pin, bar, or rod 280 that can be releasably and interchangeably mounted into a slide shaft 140′ with threads 285 or any other similarly capable fastening means. The axle impact bar 280 may also be adapted to releasably and or threadably engage the axle A of the wheel assembly WA by having a diameter small enough so as to be received in a recess AR of the axle A, which is sometimes also or alternatively referred to by those skilled in the art as a hard point or axle center point.

Also, axle impact bar 280 may also be optionally or preferably adapted with axle A threads 290 that are adapted to be threaded into OEM service threads that may be formed in the axle recess AR. In this additional configuration, the slide shaft 140′ may be further adapted with a rotation handle 295 to facilitate threading the axle impact bar into the axle threads of axle recess AR. Yet other variations may incorporate an integrally formed or otherwise attached wrench socket 297 or the like, such as a ¾″ socket, that can be actuated to rotate the slide shaft 140′.

In the configuration wherein the axle impact bar, rod, or pin 280 is configured without threads about any portion thereof (see, for example, FIG. 7), a modified axle impact rod 280′ is described that is slidably and rotatably received in the interchangeable rotor securing tool 250 within a slide shaft recess 300 that is formed in the slide shaft 140′.

In variations of the solid core shaft 140′, the instant modification may also incorporate a similar construction that employs a hollow tube-type shaft (not shown) whereby the axle 280′ can be extracted using an elongated pin inserted through the opposite end of the hollow shaft that can be used to impact the axle bar 280′ if it becomes jammed during operation.

In the instant arrangement of FIGS. 5, 6, and 7, the axle impact bar or rod 280′ may also further preferably or optionally incorporate a shoulder portion 305 (FIG. 7) that can be seated against a hard steel seat washer 310 that can in turn be seated against the proximate end 315 of the slide shaft 140′. In this modification, the axle rod 280′ may be sized whereby the slide shaft recess 300 projects further than the received portion of the axle rod or bar 280′ so that the axle bar 280′ does not bottom out within the recess 300 and thereby become deformed and jammed into the recess 300.

In this way, in addition to forming the recess 300 to be diametrically larger than the received portion of the axle bar 280′, deformation of the axle bar or rod 280′ can in most operational circumstances be limited to exterior portions proximate the shoulder portion 305 instead of portions received within the recess 300, which can prevent the axle bar or rod from becoming jammed into the recess 300. For stress relief and to minimize deformation during operation, the proximate end 315 may be further modified to incorporate a blend or chamfer 320. In addition to incorporating any of the preceding anti-deformation and anti-jamming features and capabilities, the opposite end of the axle rod or bar 280′ may also be preferably or optionally configured to have a reduced cross-section 325 having a point 327 that can be sized and adapted to automatically seat into the center or hard point axle recess AR of the axle A.

In this alternative non-threaded configuration of the axle bar or rod 280′, the operator or user of the contemplated axle impact bar 280′ can be assured that all operational impact loads, e.g., Li, are directed-along the most desirable load pathway. For example, it can be desirable to have the operational impact load, such as Li, imparted upon the axle A only in one direction while the impact loads imparted upon the rotor R are desirable only in the opposite direction such that the components may be more quickly separated from one another in circumstances where they have become seized or otherwise undesirably joined together.

With continued reference also again to FIG. 6, those having skill in the art will recognize that the stroke 330 of the hammer (such as hammer 120 of FIGS. 1 through 4) moving in the direction of arrow denoted generally by arrow 340 can, in particular coupling configurations of the securing tool 250 and housing 255, impart a shock load and transfer the linear momentum of the hammer stroke primarily or only to the axle bar or rod 280′ without any significant force being transmitted through the housing 255 of tool 250 (FIG. 6) of the interchangeable rotor securing tool 250, as is further detailed hereinbelow.

In the context of the structural configuration needed to accomplish this possibly preferred capability, the alternative axle rod, pin, bar, or shaft 280′ (FIG. 7) is incorporated into the assembly of interchangeable tool 250 (FIG. 6) so that a minimum distance L is established between the coupling surface CS of the rotor R (FIG. 6) and the interior surface 257 of the housing 255, to have a distance that is greater, even if only slightly greater, than the distance denoted by reference letter L′ (FIG. 6). Where L′ is measured between the housing coupling surface HS (FIG. 6) and end or surface 258 of the modified slide shaft 140′, which is tightened towards the coupling surface CS to extend into the interior of the housing 255. With use of the hard and tempered steel materials contemplated for use with the instant invention, even the smallest of differences between L and L′ can establish significant compressive forces so as to ensure preferred or optional pre-loading of the housing 255 and the axle rod 280, 280′ during operation of the slide hammer 120. In this way, compressive forces can be imparted in the direction of arrow 340 (FIG. 6) upon pin 290 and against axle recess AR and axle A.

To further explicate the currently illustrated modification of FIGS. 5, 6, and 7, in operation, the instant configuration 100′ of the interchangeable rotor securing tool 250 and the slide hammer (such as hammer 120 shown, for example, in FIGS. 1 through 4) are operated as explained in connection with embodiments described elsewhere herein and in the directions generally denoted by reference arrow labeled 330, but also so as to establish impact loads that are also imparted against the securing tool 250, as well as the hammer stop 150 (FIGS. 1 through 4), as can be understood with reference to direction arrows labeled 340, 350.

Such additional operational impact loads will operate to effectively separate the rotor plate R away from the wheel assembly WA. In this illustrated configuration, impact loads can be communicated to the rotor plate R in one direction denoted by arrow 350 and to the axle A generally in the opposite direction of force arrow 340.

Even more preferably, for further improved predictive load pathway capabilities, the axle rod 280′ (FIG. 7) can be incorporated and adjusted to be in compression between the axle A of the wheel assembly WA and the housing 255 of the rotor securing tool 250 by rotation of the slide shaft 140′. This adjustment capability of the slide shaft 140′ and axle impact bar 280′ combination can be preferably established by incorporating optional or preferred threads 360 (FIG. 6). In this threaded and adjustable variation, the housing 255 can be coupled to the rotor plate R whereby the rocker clamps 265 are initially positioned and loosely fastened to the slots 260.

Next, the slide shaft 140′ (being received with the alternative axle impact rod or bar 280′) is rotated to put the bar or rod 280′ into compression as noted and depicted. Then, the rocker clamps 265 are further tightened to clamp the housing 255 of the interchangeable rotor securing tool 250 to the rotor plate R. Next, the slide hammer 120 is actuated through one or more one cycles as desired and in the directions of arrow 330 outwardly in the direction of arrow 350 and then in the opposite direction of arrow 340.

As the rotor plate R begins to separate from the wheel assembly WA, the slide shaft 140′ is further tightened to increase and or to reestablish the compressive force upon the axle impact bar or rod 280′. In the circumstance where the wheel assembly WA components do not commence separation, a heating source such as an acetylene torch can be employed and can utilize one or more apertures 370, 380 (FIG. 6) that can be preferably or optionally formed in the housing 255 to receive a nozzle of such a torch.

Such a heating source can be then directed at the appropriate structures of the wheel assembly WA to impart additional temperature differential induced stresses across the interface between the wheel assembly WA components that are seized together. As the components of the wheel assembly WA are heated to dissimilar temperatures, the hammer cycle steps explicated here are repeated and separation of the previously seized components will then be accomplished.

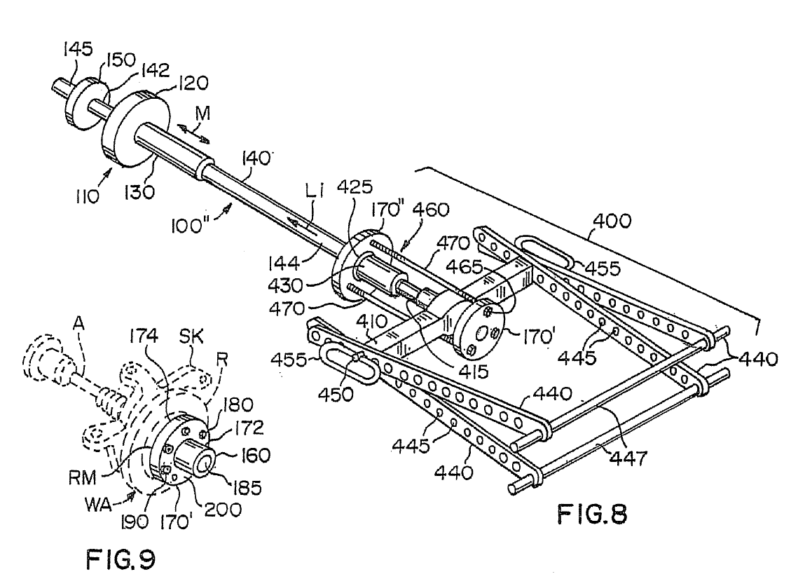

With continued reference to the various figures and now also to FIG. 8, those skilled in the art may comprehend additional variations compatible for independent use or use in combination with any of the preceding embodiments. Specifically, a modification is contemplated wherein an automotive wheel assembly removal apparatus 100″ is adapted as before to be connected to a wheel assembly and to include a slide hammer assembly 110 having a slide-tube 130 mounted hammer 120 received on a slide shaft 140 with a distal hammer stop 150 and a proximal end 144 with a coupler 160.

As can be understood from FIG. 9, a modified interchangeable rotor securing tool 170′ can be mounted to the coupler 160 and be adapted with at least one engagement hole pattern. A further modified configuration contemplates a tensioner coupling feature 185 that can be formed from any number of possible fastening features, including, for purposes of example without limitation, fastener threads.

A tensioner assembly 400 is also included and can incorporate a second interchangeable rotor securing tool such as modified tool 170′, as well as another interchangeable rotor securing tool 170″. The tensioner assembly 400 is further directed to a cross bar 410 having a generally centrally positioned central bore 415. The central bore 415 is preferably sized to be received about the second interchangeable rotor securing tool. Even more preferably, the central bore 415 is sized and positioned for receipt about coupler 160 of the rotor securing tool 170′.

In operation, the cross bar 410 imparts loads to the other components of the tensioner assembly 400 but does not typically come in contact with or otherwise impart any forces or loads to or against the second interchangeable rotor securing tool 170′. In this way, the contemplated tension loads are established between the rotor securing tools 170′ and 170″

This arrangement sets up a preload there between to improve the removal capability of the removal assemblies 100, 100′, 100″ in the many contemplated configurations. Experience has proven that establishing a preloading tension between the rotor R that has become seized, and the vehicle chassis such as wheel assembly WA can drastically reduce the time needed to remove the rotor R and or other components of the wheel assembly WA.

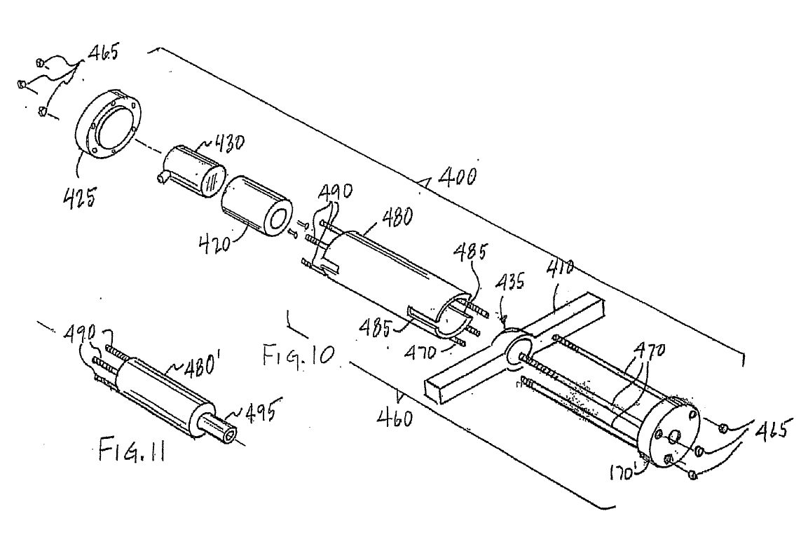

As may be understood with reference also now to FIG. 10, additional modified optional or preferred embodiments may adopt the tensioner assembly 400 to be configured to receive a plunger-cylinder assembly 430. The plunger-cylinder assembly can be seated between the cross bar and the slide hammer assembly 110 in a compression arrangement, but to impart tension forces between the rotor securing tools 170′ and 170″. Many possible plunger cylinders are compatible for use with the instant invention and can include, for illustration purposes without limitation, the RCS-101 and related series plunger cylinders available from ENERPAC, www.enerpac.com.

In various optional or preferred arrangements, the plunger cylinder assembly can be a manually or automatically actuated pneumatic, hydraulic, pneudraulic, and similarly capable device that can impart substantial forces, which will enhance the preload that can be developed during operation. An optional push cap 420 (FIG. 10) can be included between the cylinder plunger 430 and the cross bar 410 for configurations where an additional spacer may needed to accommodate the particular geometry of the removal operation.

Optional or preferred counter bores may be formed in the interchangeable rotor securing tool 170″ and the cross bar 410 for added convenience in seating the plunger cylinder. For example, counter bore seat 425 (FIGS. 8, 10) can be formed in securing tool 170″, and a counter bore seat 435 (FIG. 10) can be similarly formed in the cross bar 410 to enable more straightforward centering of the plunger cylinder assembly 430 in the tensioner assembly 400.

A tension link assembly 460 is fastened in the tensioner assembly 400 between the interchangeable rotor securing tools 170′, 170″. A plurality of push links 440 are adjustably and movably pinned to opposite ends of the cross bar 410. A series of adjustment apertures 445 can be included whereby push link pins 450 can engage the push links 440 to the ends of the cross bar 410. Further, the pins 450 can include handles 455 for lifting and positioning the tensioner assembly 400.

Preferably, each of the plurality of push links 440 is configured to be long enough to extend between the tensioner assembly 400 and to urge and seat against the vehicle chassis, such as the wheel assembly WA and components thereof. In optional embodiments, the push links 440 can further include straight or curved or specially shaped push rods 447. Although push rods 447 are shown in FIG. 8 to be straight, which is especially useful when needed to urge against leaf-spring-type under carriage components, many other optional push rod 447 configurations are contemplated to accommodate use of the tensioner assembly 400 with rocker arms, control arms, chassis frame longerons, and other under carriage structures that may be available on a given vehicle for establishing a firm seat against which the removal apparatus 100, 100′, 100″ can be situated.

In one possibly preferred or optional arrangement, the tension link assembly 460 can incorporate a plurality of tension rods 470 that can be secured with what are commonly referred to by those skilled in the automotive arts as lug nuts 465 (FIG. 10). The tension rods 470 can be received in existing engagement holes of the contemplated hole patterns discussed elsewhere herein. Alternatively, additional hole patterns can be formed with through holes for use with the tension rods 470.

In other alternative adaptations, the lug nuts 465 are not needed when the tension rods 470 can be threaded into integral bores that can be formed in the rotor securing tools 170, 170′, 170″. In each of these possible variations, the objective is to balance the tensile loads and it is recommended that at least two and more preferably three or more tension rods 470 be used as described.

Further modifications to any of the preceding embodiments can optionally or preferably include a differently configured tension link assembly 460 wherein a tension cylinder 480 is used alone and or in combination with the tension rods 470. In FIGS. 10 and 11, those knowledgeable in the relevant arts may come to know that the instant invention can incorporate the tension cylinder 480 to be a generally hollow tube with cross bar clearance slots 485 and lug bolts 490 that can be integrally formed about the cylinder 480.

In other variations, a modified tension cylinder 480′ may be adapted with a tension stem 495 (FIG. 11), which is adapted with internal fastening means such as threads configured to threadably receive the tensioner coupling feature 185. In this modification, the tensioner stem 495 is sized for receipt through the central bore 415 of the cross bar 410 and to be threadably received on the tensioner coupling feature 185 formed on the coupler 160 of the rotor securing tool 170′.

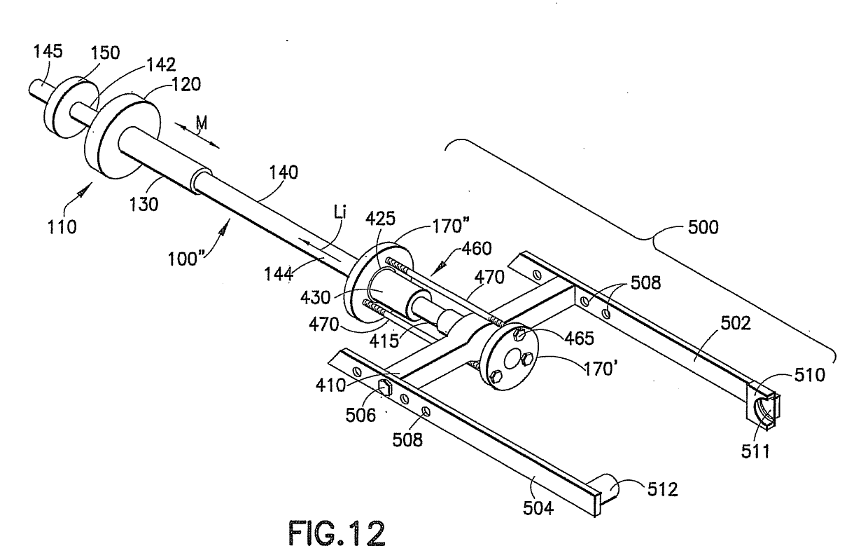

The wheel assembly removal apparatus 100″ may also be adapted with other tensioner assembly embodiments for use with the slide hammer and/or the plunger cylinder embodiments discussed above. For example, FIG. 12 depicts a further embodiment of a tensioner assembly 500. The tensioner assembly 500 has a first or upper push link 502 and a second or lower push link 504 that each are attached adjacent opposite ends of the cross bar 410, such as by a bolt 506. The push links 502 and 504 have adjustment apertures 508 through which the bolt 506 can be inserted so as to adjustably connect with the cross bar 410. In this manner, the push links 502 and 504 can be adjusted and moved to extend at different lengths from the cross bar 410. Other methods of attachment instead of, or in addition to, a bolt 506 may be used to connect the push links 502 and 504 to the cross bar 410, such as, for example, pins 450 with optional handles 455 as shown in the embodiment described in connection with FIG. 8.

The distal ends of opposing links 502 and 504 are structured so as to accommodate appropriate portions of the wheel assembly, such as opposing portions of a ball joint. For example, the upper push link 502 may include an upper-gripping member 510 at the distal end of the link 502 that extends radially inwardly from the upper push link 502. The upper gripping member 510 may be a generally rectangular block, but with a generally arc-shaped cut-away portion removed from the most distal side of the gripping member 510 to form a cavity 511. The lower push link 504 may further include a lower gripping member 512 that is a generally tubular hollow structure, extending radially inward from the lower push link 504. The gripping members 510, 512 can be made of any appropriate material, and are desirably metal that can be welded or otherwise connected to the push links 502 and 504.

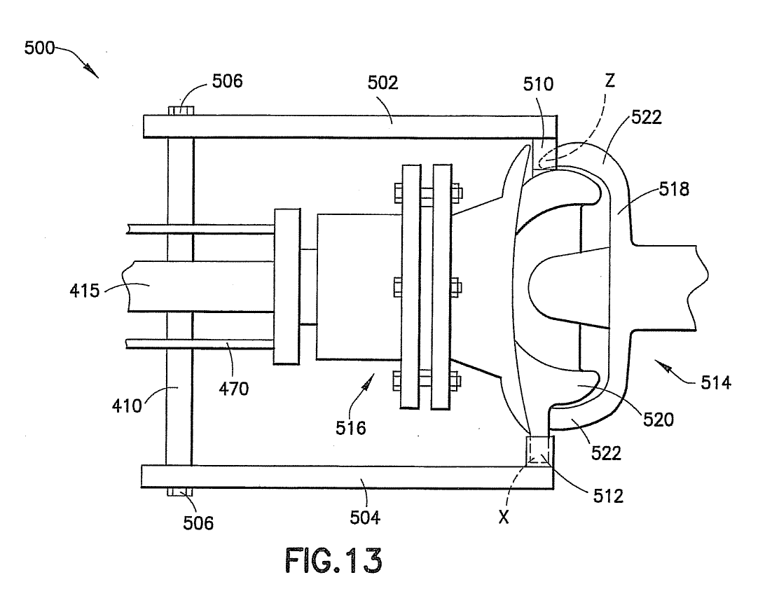

FIG. 13 shows the tensioner assembly 500 engaged with a portion of the vehicle chassis known as a ball joint 514 that is connected to a wheel assembly 516. The ball joint has an exterior portion 518 and an interior portion 520. Generally speaking, the exterior portion 518 of the ball joint 514 also has exterior elements 522 that extend around the top and bottom of the ball joint 514. The push links 502 and 504 are sized and configured so that the gripping members 510 and 512 can engage with the ball joint 514, as shown in FIG. 13, giving them a suitable length to seat and urge against the vehicle chassis and components thereof.

The lower gripping member 512 engages with the interior portion 520 of the ball joint 514 at a location on the interior portion 520 that extends downward from the inside of the ball joint 514. An internal opening through the hollow portion of gripping member 512 can accommodate a corresponding part of the ball joint 514 for maintaining gripping member 512 securely in place, as shown by the partial cross section in FIG. 13 at point X. The cavity 511 of the upper gripping member 510 is sized and configured to receive the top exterior element 522. A partial cross section is shown in FIG. 13 at point Z to illustrate how the exterior element 522 fits with the upper gripping member 510 inside of the cavity 511. Thus, although the upper gripping member 510 has been described as having a generally arc-shaped cavity, any configuration of a cavity that allows an exterior element of a ball joint to be received by it is suitable for the present invention. Likewise, although the lower gripping member 512 has been described as generally tubular, any configuration that allows the lower gripping member 512 to be connected to the interior portion 520 of the ball joint 514 is suitable for the present invention. Such variations in either of these configurations for the gripping members 510 and 512 are regarded as being within the scope of the present claimed invention.

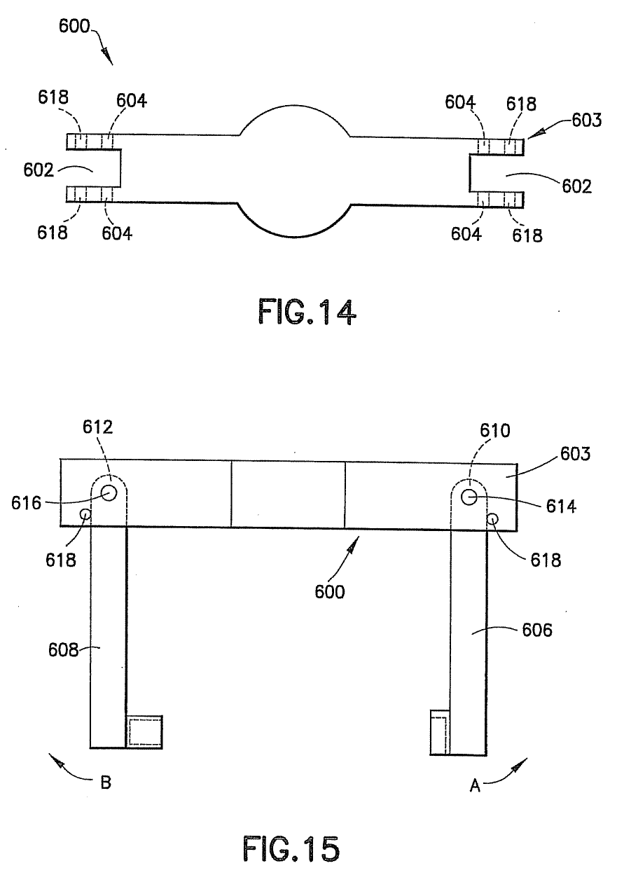

FIGS. 14-15 depict a further embodiment of a cross bar 600 for the tensioner assembly 500, shown as a sectional side view of the cross bar 600. The cross bar 600 is similar to that of cross bar 410, except that it has two channels 602 at opposite ends of the cross bar 600. The channels 602 form a groove through the ends of the cross bar leaving lips 603 above and below the channels 602. The cross bar 600 also has a set of inner holes 604 that are drilled or otherwise made in the lips 603. Although the cross bar 600 as shown is a solid piece of material with channels 602 removed, cross bar 600 can also be made from two separate pieces spaced apart from each other to form the channels 602.

FIG. 15 shows an embodiment of an upper push link 606 and a lower push link 608 that are similar to the upper and lower push links 502 and 504 respectively, except that the push links 606 and 608 have rounded ends 610 and 612. The push links 606 and 608 are sized and configured to fit into the channels 602 of the cross bar 600. The rounded ends 610 and 612 of the push links 606 and 608 have holes in them that are sized and configured to align with the inner holes 604 in the cross bar 600 when the push links 606 and 608 are in place as shown in FIG. 15. The push links 606 and 608 can then be held in place by inserting a pin, bolt, or other suitable object through the inner holes 604 of the cross bar 600 and the holes in the push links 606 and 608. This creates pivot points 614 and 616 where the push links 606 and 608 are hingedly connected to the cross bar 600. The rounded ends 610 and 612 are sized and configured to allow the push links 606 and 608 to rotate about the pivot points 614 and 616. Although the hinged connection of the push links 606 and 608 has been presently described as having the specific structure discussed above, many variations of creating a hinged connection are well known in the art and are regarded as being within the scope of the present invention as claimed.

The hingedly connected push links 606 and 608 as shown in FIG. 15 can be rotated in directions A and B, respectively, allowing them to pivot while being brought into engagement with a vehicle chassis as shown in FIG. 13. Once properly engaged with the vehicle chassis, the push links 606 and 608 are in the orientation shown in FIG. 15. In order to keep the push links 606 and 608 from rotating in directions A and B while the push links 606 and 608 are engaged with the vehicle chassis, the lips 603 of the cross bar 600 can have outer holes 618. A pin, bolt, or other fixing member can be inserted through one of the outer holes 618 such that it is adjacent to a portion of the push links 606 or 608 to prevent the push links from rotating in directions A and B, respectively. While the push links 606 and 608 are herein described as being fixed with a pin, bolt, or other fixing member being inserted into the lips 603 of the cross bar 600, other means to fix the push links 606 and 608 in place are well known in the art and are regarded as being within the scope of the present claimed invention.

Alternatively, or additionally, an elastic cord or other sort of restraint can be wrapped around both push links 606 and 608 of the tensioner assembly 500 to prevent the push links 606 and 608 from rotating out of position before the pressure is applied to the push links 606 and 608 in the direction of the vehicle chassis. The push links 606 and 608 can also have small notches cut out of them so that the cord can fit into the notch on the each push link, preventing the cord from slipping out of place on the push links 606, 608.

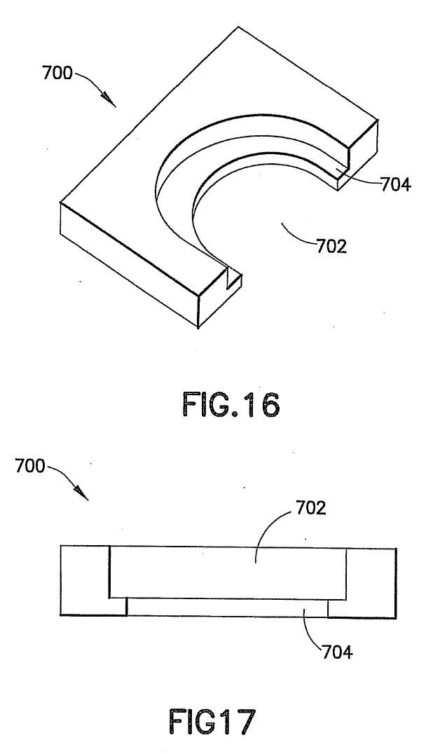

FIGS. 16 and 17 show an embodiment of a gripping member 700 which is similar to gripping member 510, and includes a cavity 702. The upper gripping member 700 also has a lip 704 that runs along the bottom edge of the cavity 702, extending outward therefrom. The lip 704 is sized and configured to fit beneath the top exterior element 522 of the exterior portion 518 of the ball joint 514 at point Z, shown in FIG. 13. The gripping member 700 engages with the top exterior element 522 in the manner shown in FIG. 13, and has the lip 704 engaged with the underside of the top exterior element 522. As so engaged, when the push links 502 and 504 push against the vehicle chassis, the lip 704 prevents the force of the upper push link 502 from causing the gripping member 700 to disengage with the top exterior element by being forced upward and off of the top exterior element 522. The lip 704 thus interferes with and prevents the vertical movement of the gripping member 700 relative to the vehicle chassis.

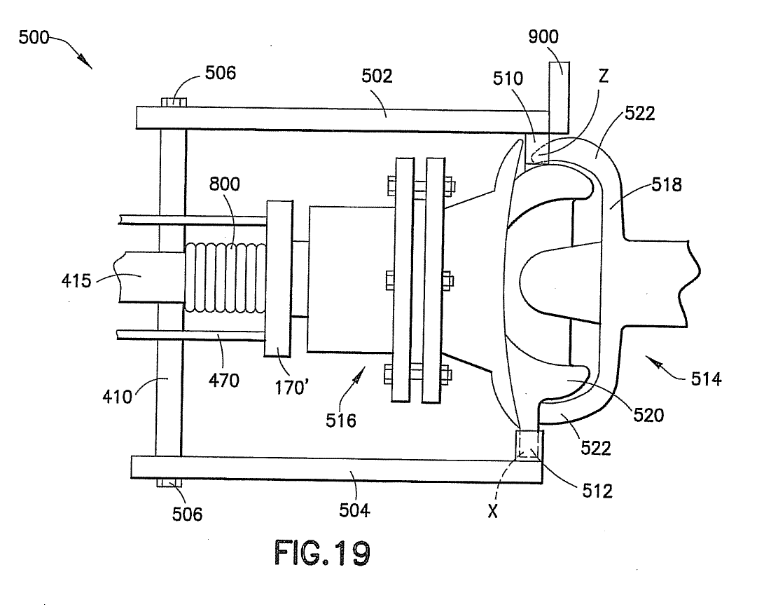

FIG. 19 shows the push link 502 with an additional push plate 900 attached at one end. The push plate extends perpendicularly upward from the push link 502 and is made of a strong and sturdy material such as steel. The push plate 900 is sized and configured to engage with other components of the vehicle chassis aside from the ball joint 514. For example, the push plate 900 can be made in different sizes and shapes and can project from the push link 502 at slightly different angles in order to properly engage with components of the vehicle chassis such as the steering knuckle. Such configurations of a push link 502 using a push plate 900 can be useful for removing wheel assemblies in two wheel drive vehicles, where the vehicle chassis components differ from those of four wheel drive assemblies. To prevent the push plate 900 from slipping off the vehicle chassis when being the tensioner assembly is being used, an elastic band, lip, or other form of restraint as described above can be wrapped around or incorporated into the push links 502 and 504. Having a push plate 900 attached to the push link 502 does not interfere with the operation of the push link 502 utilizing the upper gripping member 510. As shown in FIG. 19, both the upper gripping member 510 and the push plate 900 can be incorporated on the same push link 502 to be used in different situations.

The tensioner assembly 500 can be used in conjunction with linear actuator such as a hydraulic, pneumatic, or, pneudraulic device to push a cylinder plunger 430 in a plunger-cylinder assembly as shown in FIG. 10. The plunger 430 in the device can push on the cross bar 410 or 600 toward the vehicle chassis in a direction parallel to the axel. The cross bar 410 or 600 can then transfer the force from the plunger to the push links 502 and 504 or 606 and 608 when they are coupled to the vehicle chassis as shown in FIG. 13. While the push links push against the vehicle chassis in the direction of the vehicle, the rotor securing tool 170′ which is attached to the rotor and the plunger-cylinder assembly 430 will pull on the rotor in the opposite direction, ultimately separating the rotor from the vehicle chassis. The pressure needed to separate the rotor from the vehicle chassis can vary, and the type of device supplying the pressure (i.e., hydraulic, pneumatic, or pneudraulic) can vary accordingly with regard to such pressure requirements.

A heating source can be directed at the appropriate structures of the wheel assembly to impart additional temperature differential induced stresses across the interface between the wheel assembly components that are seized together. As the components of the wheel assembly WA are heated to dissimilar temperatures, the hydraulic, pneumatic, or pneudraulic pushing explicated here can be repeated and separation of the previously seized components can then be accomplished. A slide hammer assembly 110 as described herein can also be connected to the plunger-cylinder assembly in the manner shown in FIGS. 8 and 12. The slide hammer assembly 110 can then be used in addition to the hydraulic, pneumatic, or pneudraulic device.

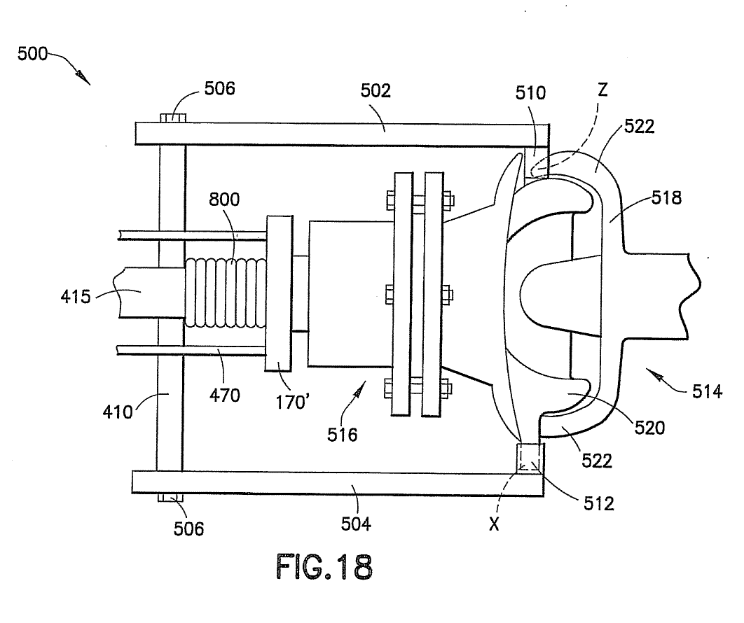

Once the wheel assembly has been removed from the vehicle chassis, the pressure of the hydraulic, pneumatic, or pneudraulic device can be decreased or eliminated. As shown in FIG. 18, a spring 800 or other biasing member can be placed between the cross bar 410 and the rotor securing tool 170′. A biasing member such as spring 800 can be sized and configured to surround the central bore 415 between the cross bar 410 and the rotor securing tool 170′. When the cross bar 410 is forced toward the vehicle chassis and moves in that direction (relative to the actuator) to remove the wheel assembly, the spring 800 can be compressed. Once the wheel assembly has been removed from the vehicle chassis, and the pressure applied by the hydraulic, pneumatic, or pneudraulic device has been decreased or eliminated, the spring 800 can push the cross bar 410 away from the vehicle chassis to put the cross bar 410 back into its initial position. Accordingly, the spring 800 biases the cross bar 410 away from the vehicle chassis, eliminating the need for an operator of the tensioner assembly 500 to manually move the cross bar 410 back into its initial position. The amount of force applied by the biasing member is enough to push the cross bar 410 away from the vehicle chassis when the actuator is not applying any force toward the vehicle chassis. However, the amount of force applied by the biasing member is not enough to prevent the cross bar 410 from moving toward the vehicle chassis when being pushed by the actuator, which would prevent the tensioner assembly 500 from effectively removing the wheel assembly.

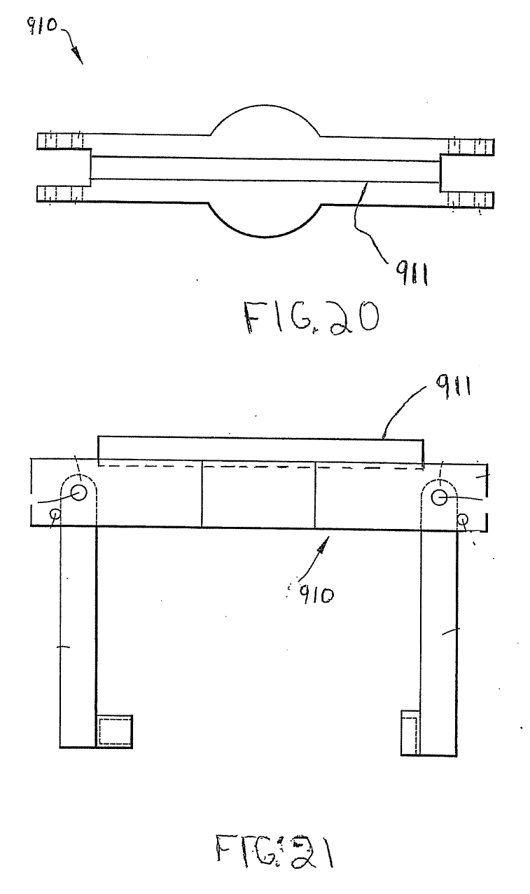

FIGS. 20-21 depict a further embodiment of a cross bar 910. FIG. 20 shows a sectional side view of the cross bar 910. A gusset 911 is attached to the cross bar 910 on the distal side of the cross bar 910 as shown in FIG. 21. Gusset 911 may be attached to the cross bar 910 by welding or any other suitable method that is known in the art. Gusset 911 operates to strengthen cross bar 910 so as to prevent deflection of cross bar 910 during use. Additionally, use of gusset 911 may allow cross bar 910 to be made of a less expensive material. Further, gusset 911 may be made to a certain length and mounted into cross bar 910 at a certain depth so as to prevent the push link (such as push link 608 in FIG. 15) from dropping down far enough to hit the operator. Rather the push link will only rotate far enough to release itself from the wheel assembly. The embodiment of the cross bar 910 with attached gusset 911 depicted in FIGS. 20 and 21 may be incorporated into any of the aforementioned embodiments.

Numerous alterations, modifications, and variations of the preferred embodiments, configurations, modifications, variations, and alternatives disclosed herein will be apparent to those skilled in the art and they are all contemplated to be within the spirit and scope of the instant invention. For example, although specific embodiments have been described in detail, those with skill in the art can understand that the preceding embodiments and variations can be further modified to incorporate various types of substitute and/or additional materials, components, shapes, relative arrangement of elements, and dimensional and proportional configurations.

Such optional or preferred variations can be particularly well-adapted for compatibility with the wide variety of industrial, commercial, and professional vehicle maintenance service environments known to those working in the field and available in the respective industries. Accordingly, even though only few variations of the present invention are described herein, it is to be understood that the practice of such additional modifications and variations and the equivalents thereof, are within the spirit and scope of the invention as defined in the following claims.

The invention claimed is:

1. An apparatus for removing an automotive wheel assembly from a vehicle chassis comprising:
a linear actuator;
a cross bar;
a rotor securing tool connected on one side to the linear actuator and adapted on the other side to connect to a rotor of the wheel assembly; and
at least one push link attached to the cross bar, the push link being adapted with a length to seat and urge against a vehicle chassis;
the linear actuator being configured to apply a load to the cross bar such that the load is transferred through the push link to the vehicle chassis in a direction parallel to the axle of the wheel assembly.

2. The apparatus of claim 1, wherein the linear actuator is a hydraulic, pneumatic, or pneudraulic device.

3. The apparatus of claim 1, wherein the linear actuator is a plunger-cylinder assembly.

4. The apparatus of claim 1, wherein the push link is adjustably and movably attached to the cross bar.

5. The apparatus of claim 1, wherein the push link is hingedly attached to the cross bar.

6. The apparatus of claim 5, further comprising a fixing member.

7. The apparatus of claim 1, wherein the push link further comprises a gripping member.

8. The apparatus of claim 7, wherein the gripping member is generally tubular.

9. The apparatus of claim 7, wherein the gripping member further comprises a cavity.

10. The apparatus of claim 7, wherein the gripping member further comprises a lip.

11. The apparatus of claim 1, further comprising rocker clamps attached to the rotor securing tool.

12. The apparatus of claim 1, further comprising a slide hammer assembly connected to the linear actuator.

13. The apparatus of claim 1, further comprising a biasing member disposed between the cross bar and the rotor securing tool.

14. The apparatus of claim 1, wherein the push link further comprises a push plate.

15. A method for removing an automotive wheel assembly from a vehicle chassis, comprising the steps of:
connecting a rotor securing tool to a rotor of the wheel assembly;
connecting a linear actuator to the rotor securing tool, the linear actuator being adapted to push a cross bar relative to the linear actuator;
connecting a push link to the vehicle chassis, the push link being connected to the cross bar; and
having the linear actuator apply a load to the cross bar in the direction of the vehicle chassis, causing the push link to push against the vehicle chassis while maintaining the rotor securing tool fixed in position.

16. The method of claim 15, wherein the linear actuator is a hydraulic, pneumatic, or pneudraulic device.

17. The method of claim 15, wherein the push link is hingedly attached to the cross bar.

18. The method of claim 15, wherein the push link further comprises a gripping member.

19. The method of claim 15, further comprising the steps of:
attaching a slide hammer assembly to the linear actuator; and
sliding a hammer in the slide hammer assembly to generate linear momentum until it makes contact with a hammer stop, such that the hammer delivers an impact load pulling the wheel assembly away from the vehicle chassis.

20. The method of claim 15, further comprising the step of heating portions of the wheel assembly to impart temperature differential induced stresses across the interface between wheel assembly components that are seized together.
